(19) United States
(12) Patent Application Publication
(10) Pub. No.: US 2022/0164629 A1
(43) Pub. Date: May 26, 2022

(54) ELECTRONIC DEVICE FOR COMPRESSING CONVOLUTIONAL ARTIFICIAL INTELLIGENCE NEURAL NETWORK MODEL AND METHOD OF CONTROLLING THE ELECTRONIC DEVICE

(71) Applicant: SAMSUNG ELECTRONICS CO., LTD., Suwon-si (KR)

(72) Inventors: Youngcheon YOU, Suwon-si (KR); Jeongin Yun, Suwon-si (KR); Youngyoon Lee, Suwon-si (KR); Jinsu Yeo, Suwon-si (KR); Jaechool Lee, Suwon-si (KR)

(73) Assignee: SAMSUNG ELECTRONICS CO., LTD., Suwon-si (KR)

(21) Appl. No.: 17/528,535

(22) Filed: Nov. 17, 2021

Related U.S. Application Data
(63) Continuation of application No. PCT/KR2021/013212, filed on Sep. 28, 2021.

(30) Foreign Application Priority Data
Nov. 20, 2020 (KR) 10-2020-0156922

(51) Int. Cl. G06N 3/04

(52) U.S. Cl. CPC G06N 3/04

(57) ABSTRACT

Provided are an electronic device and a method of compressing a convolutional neural network (CNN) including at least one convolution layer. The method includes identifying a convolution tensor of the at least one convolution layer; determining a tiling direction for the convolution tensor based on a shape of the convolution tensor; generating a tile matrix from the convolution tensor along the tiling direction; generating a U matrix and a V matrix by performing low rank approximation (LRA) on the tile matrix; and generating a U convolution tensor by recombining the U matrix and generating a V convolution tensor by recombining the V matrix.

### CROSS-REFERENCE TO RELATED APPLICATION(S)

This application is a by-pass continuation application of International PCT Application No. PCT/KR2021/013212, filed Sep. 28, 2021, which is based on and claims priority to Korean Patent Application No. 10-2020-0156922, filed Nov. 20, 2020 in the Korean Intellectual Property Office, the disclosures of which are incorporated by reference herein in their entirety.

### BACKGROUND

### 1. Field

The disclosure relates to an electronic device for compressing a convolutional artificial intelligence (AI) neural network model by performing low rank approximation (LRA) on the convolutional AI neural network model, and a method of compressing the convolutional AI neural network model by using the electronic device.

### 2. Description of Related Art

An artificial intelligence (AI) system is a computer system that implements human-level intelligence, and allows a machine to learn, make decisions, and become smarter, by itself, unlike an existing rule-based smart system. The more the AI system is used, the greater its recognition rate and the more accurate the AI system understands users' preferences, and as a result, existing rule-based smart systems have been gradually replaced by deep-learning-based AI systems.

AI technology includes machine learning (e.g., deep learning) and element technologies using machine learning.

Machine learning refers to an algorithm technology in which a machine classifies and learns characteristics of input data autonomously, and element technologies refer to technologies using a machine learning algorithm, such as deep learning, and may be divided into the fields of linguistic understanding, visual understanding, reasoning/prediction, knowledge representation, operation control, etc.

At an initial stage of designing an AI neural network model, an AI neural network model is generated by using a large number of parameters to allow the AI neural network model to easily learn training data. As fields where AI technology is used have diversified and the amount of data used for machine learning has rapidly increased, the AI neural network model generated through machine learning may use a lot of space in memory.

However, the AI neural network model generated using a large number of parameters may not be appropriate for an electronic device (e.g., a portable terminal) requiring a small-size AI neural network model.

Hence, there is a need to reduce the size of the AI neural network model by a method of compressing the AI neural network model.

As a related method of compressing a convolutional AI neural network model, low rank approximation (LRA) may be performed on each layer of the AI neural network model. Low rank approximation (LRA) is a method of compressing the convolutional AI neural network model by dividing an M×N two-dimensional (2D) matrix into an M×R 2D matrix and an R×N 2D matrix according to a rank (R).

However, when related LRA is performed on a convolution layer, deformation of a convolutional structure of the AI neural network model is required, such that a convolution operation may not be accelerated using hardware and software that are established properly for an existing convolutional structure.

### SUMMARY

Provided are an electronic device for compressing a convolutional artificial intelligence (AI) neural network model, which maximizes a compression rate while minimizing an accuracy loss, and a method of compressing the convolutional AI neural network model by using the electronic device.

Also, provided are an electronic device for compressing a convolutional AI neural network model, which is capable of accelerating a convolution operation by using hardware and software that are established properly for an existing convolutional structure, and a method of compressing the convolutional AI neural network model by using the electronic device.

Technical aspects, features and advantages to be achieved by one or more embodiments of the disclosure may not be limited to the technical problems described above.

According to an embodiment, there is provided an electronic device for compressing a convolutional neural network (CNN) including at least one convolution layer. The electronic device includes: a memory storing at least one instruction; and a processor configured to execute the at least one instruction to: identify a convolution tensor of the at least one convolution layer; determine a tiling direction for the convolution tensor based on a shape of the convolution tensor; generate a tile matrix from the convolution tensor along the tiling direction; generate a U matrix and a V matrix by performing low rank approximation (LRA) on the tile matrix; and generate a U convolution tensor by recombining the U matrix and generate a V convolution tensor by recombining the V matrix.

The processor is further configured to execute the at least one instruction to: divide the convolution tensor into a plurality of sub-matrices comprising a row of a size corresponding to a size of an input channel and a column of a size corresponding to a size of an output channel; and determine tiling directions for the plurality of sub-matrices based on the size of the input channel of the convolution tensor, the size of the output channel of the convolution tensor, a number of columns of a convolution kernel formed by the convolution tensor, and a number of rows of the convolution kernel.

The processor is further configured to execute the at least one instruction to determine the tiling directions for the plurality of sub-matrices based on a result of comparing a greater value between the number of columns of the convolution kernel and the number of rows of the convolution kernel with a ratio of the size of the output channel to the size of the input channel.

The processor is further configured to execute the at least one instruction to determine to tile the plurality of sub-matrices vertically based on the greater value between the number of columns of the convolution kernel and the number of rows of the convolution kernel being less than the ratio of the size of the output channel to the size of the input channel.

The processor is further configured to execute the at least one instruction to determine to tile the plurality of sub-matrices horizontally based on a reciprocal of the greater value between the number of columns of the convolution kernel and the number of rows of the convolution kernel being greater than the ratio of the size of the output channel to the size of the input channel.

The processor is further configured to execute the at least one instruction to determine to tile the plurality of sub-matrices horizontally as many as the number of columns of the convolution kernel and determine to tile the plurality of sub-matrices vertically as many as the number of rows of the convolution kernel, based on a result of the greater value between the number of columns of the convolution kernel and the number of rows of the convolution kernel being greater than the ratio of the size of the output channel to the size of the input channel, and the reciprocal of the greater value between the number of columns of the convolution kernel and the number of rows of the convolution kernel being less than the ratio of the size of the output channel to the size of the input channel, respectively.

The processor is further configured to execute the at least one instruction to: identify a sharing matrix from the tile matrix along at least one of the tiling directions for the plurality of sub-matrices; and generate the U matrix and the V matrix by performing the LRA based on the identified sharing matrix.

The processor is further configured to execute the at least one instruction to identify a top row of the tile matrix as a sharing matrix, based on a result of the greater value between the number of columns of the convolution kernel and the number of rows of the convolution kernel being less than the ratio of the size of the output channel to the size of the input channel.

The processor is further configured to execute the at least one instruction to identify a left column of the tile matrix as a sharing matrix, based on a result of a reciprocal of the greater value between the number of columns of the convolution kernel and the number of rows of the convolution kernel being greater than the ratio of the size of the output channel to the size of the input channel.

The processor is further configured to execute the at least one instruction to identify the top row of the tile matrix and the left column of the tile matrix as the sharing matrix, based on a result of the greater value between the number of columns of the convolution kernel and the number of rows of the convolution kernel being greater than the ratio of the size of the output channel to the size of the input channel and the reciprocal of the greater value between the number of columns of the convolution kernel and the number of rows of the convolution kernel being less than the ratio of the size of the output channel to the size of the input channel.

According to an embodiment, there is provided a method of compressing a convolutional neural network (CNN) including at least one convolution layer, performed by an electronic device. The method includes: identifying a convolution tensor of the at least one convolution layer; determining a tiling direction for the convolution tensor based on a shape of the convolution tensor; generating a tile matrix from the convolution tensor along the tiling direction; generating a U matrix and a V matrix by performing low rank approximation (LRA) on the tile matrix; and generating a U convolution tensor by recombining the U matrix and generating a V convolution tensor by recombining the V matrix.

The determining the tiling direction for the convolution tensor includes: dividing the convolution tensor into a plurality of sub-matrices comprising a row of a size corresponding to a size of an input channel and a column of a size corresponding to a size of an output channel; and determining tiling directions for the plurality of sub-matrices based on the size of the input channel of the convolution tensor, the size of the output channel of the convolution tensor, a number of columns of a convolution kernel formed by the convolution tensor, and a number of rows of the convolution kernel.

The determining the tiling direction for the convolution tensor further includes determining the tiling directions for the plurality of sub-matrices based on a result of comparing a greater value between the number of columns of the convolution kernel and the number of rows of the convolution kernel with a ratio of the size of the output channel to the size of the input channel.

The determining the tiling direction for the convolution tensor further includes determining to tile the plurality of sub-matrices vertically based on the greater value between the number of columns of the convolution kernel and the number of rows of the convolution kernel being less than the ratio of the size of the output channel to the size of the input channel.

The determining the tiling direction for the convolution tensor further includes determining to tile the plurality of sub-matrices horizontally based on a reciprocal of the greater value between the number of columns of the convolution kernel and the number of rows of the convolution kernel being greater than the ratio of the size of the output channel to the size of the input channel.

The determining the tiling direction for the convolution tensor further includes determining to tile the plurality of sub-matrices horizontally as many as the number of columns of the convolution kernel and determining to tile the plurality of sub-matrices vertically as many as the number of rows of the convolution kernel, based on a result of the greater value between the number of columns of the convolution kernel and the number of rows of the convolution kernel being greater than the ratio of the size of the output channel to the size of the input channel, and the reciprocal of the greater value between the number of columns of the convolution kernel and the number of rows of the convolution kernel being less than the ratio of the size of the output channel to the size of the input channel, respectively.

The generating the U matrix and the V matrix includes: identifying a sharing matrix from the tile matrix along at least one of the tiling directions for the plurality of sub-matrices; and generating the U matrix and the V matrix by performing the LRA based on the identified sharing matrix.

The identifying the sharing matrix includes identifying a top row of the tile matrix as a sharing matrix, based on a result of the greater value between the number of columns of the convolution kernel and the number of rows of the convolution kernel being less than the ratio of the size of the output channel to the size of the input channel.

The identifying the sharing matrix includes identifying a left column of the tile matrix as a sharing matrix, based on a result of the reciprocal of the greater value between the number of columns of the convolution kernel and the number of rows of the convolution kernel being less than the ratio of the size of the output channel to the size of the input channel.

The identifying the sharing matrix includes identifying the top row of the tile matrix and the left column of the tile matrix as the sharing matrix, based on a result of the greater value between the number of columns of the convolution kernel and the number of rows of the convolution kernel being greater than the ratio of the size of the output channel to the size of the input channel and the reciprocal of the greater value between the number of columns of the convolution kernel and the number of rows of the convolution kernel is less than the ratio of the size of the output channel to the size of the input channel.

According to another embodiment of the disclosure, a computer-readable recording medium has recorded thereon a program for executing at least one of embodiments of the disclosed method on a computer.

According to another embodiment of the disclosure, an application stored in a recording medium is intended to execute at least one function of embodiments of the disclosed method.

### BRIEF DESCRIPTION OF THE DRAWINGS

FIG. 1 is a view for describing an example of a method, performed by an electronic device, of compressing an artificial intelligence (AI) neural network model according to an embodiment of the disclosure.

FIG. 2 is a flowchart of a method, performed by an electronic device, of compressing an AI neural network model, according to an embodiment of the disclosure.

FIG. 3 is a view for describing an example of a method, performed by an electronic device, of tiling a convolution tensor, according to an embodiment of the disclosure.

FIG. 4 is a view for describing an example of a method, performed by an electronic device, of tiling a convolution tensor, according to an embodiment of the disclosure.

FIG. 5 is a view for describing an example of a method, performed by an electronic device, of tiling a convolution tensor, according to an embodiment of the disclosure.

FIG. 6 is a view for describing an example of a method, performed by an electronic device, of identifying a sharing matrix from a tile matrix, according to an embodiment of the disclosure.

FIG. 7 is a view for describing an example of a method, performed by an electronic device, of identifying a sharing matrix from a tile matrix, according to an embodiment of the disclosure.

FIG. 8 is a view for describing an example of a method, performed by an electronic device, of identifying a sharing matrix from a tile matrix, according to an embodiment of the disclosure.

FIG. 9 is a view for describing an example of a method, performed by an electronic device, of generating a U matrix and a V matrix by using a sharing matrix, according to an embodiment of the disclosure.

FIG. 10 is a view for describing an example of a method, performed by an electronic device, of generating a U matrix and a V matrix by using a sharing matrix, according to an embodiment of the disclosure.

FIG. 11 is a view for describing an example of a method, performed by an electronic device, of generating a U matrix and a V matrix by using a sharing matrix, according to an embodiment of the disclosure.

FIG. 12 is a block diagram of an electronic device according to an embodiment of the disclosure.

FIG. 13 is a block diagram of a software module of a memory included in an electronic device, according to an embodiment of the disclosure.

### DETAILED DESCRIPTION

Throughout the disclosure, the expression “at least one of a, b or c” indicates only a, only b, only c, both a and b, both a and c, both b and c, all of a, b, and c, or variations thereof.

The present specification describes the principle of the disclosure and discloses embodiments of the disclosure to clarify the scope of the disclosure and to allow those of ordinary skill in the art to carry out the disclosure. Disclosed embodiments of the disclosure may be implemented in various forms.

Throughout the specification, an identical reference numeral will indicate an identical component. The present specification does not describe all elements of embodiments of the disclosure, and general information in the technical field of the disclosure or redundant information over the embodiments of the disclosure will be omitted. The term ‘part or portion’ used in the specification may be a hardware component such as a processor or circuit, and/or a software component executed by a hardware component such as a processor, and according to embodiments of the disclosure, a plurality of ‘parts or portions’ may be implemented as one unit or element or one ‘part or portion’ may include a plurality of elements. Hereinafter, the operating principle and embodiments of the disclosure will be described in detail with reference to the accompanying drawings.

Some embodiments of the disclosure may be represented by block components and various processing operations. All or some of such functional blocks may be implemented by various numbers of hardware and/or software components which perform specific functions. For example, functional blocks of the disclosure may be implemented by one or more microprocessors or circuit elements for a specific function. In addition, for example, the functional blocks of the disclosure may also be implemented as various programming or scripting languages. The functional blocks may be implemented as an algorithm executed in one or more processors. Furthermore, the disclosure may employ related techniques for electronics configuration, signal processing and/or data processing, etc. The term “mechanism”, “element”, “means”, “component”, etc. is used broadly and is not limited to mechanical or physical components.

Throughout the specification, when a part is “connected” to another part, the part is not only “directly connected” to another part but also “electrically connected” to another part with another device intervening in them. When it is assumed that a certain part includes a certain component, the term “including” means that a corresponding component may further include other components unless specially mentioned otherwise.

Connecting lines or connecting members between components shown in the drawings are intended to merely illustrate functional connections and/or physical or circuit connections. In an actual device, connections between components may be indicated by replaceable or added various functional connections, physical connections, or circuit connections.

Although the terms including ordinal numbers such as “first” and “second” used herein may be used to describe various components, these components are not limited by the terms. The terms may be used for the purpose of distinguishing one component from another component. For example, although first data or second data is described herein, this is merely used to identify the first data and the second data as being different from each other, without limiting the disclosure.

Hereinafter, embodiments of the disclosure will be described in detail with reference to the accompanying drawings.

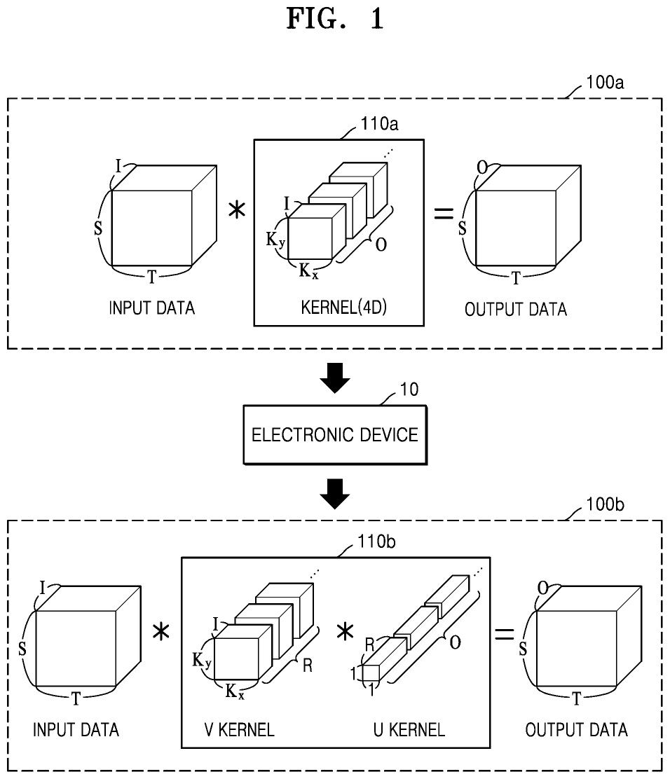

FIG. 1 is a view for describing an example of a method, performed by an electronic device, of compressing an artificial intelligence (AI) neural network model according to an embodiment.

Referring to FIG. 1, an electronic device 10 may compress a kernel of a convolution layer of an AI neural network model. For example, the electronic device 10 may compress a parameter of a convolution layer on which a one-dimensional (1D) convolution operation is performed like a voice synthesis model or a two-dimensional (2D) convolution operation is performed like an image processing model.

According to an embodiment of the disclosure, the electronic device 10 may include a computing device such as a mobile device (e.g., a smartphone, a tablet personal computer (PC), etc.), a general-purpose computer (e.g., a PC), or a server, which includes an AI neural network. The electronic device 10 may compress an AI neural network and perform a function, such as voice synthesis and image processing, by using the compressed AI neural network, according to a disclosed embodiment of the disclosure.

The electronic device 10 may include a computing device such as a mobile device (e.g., a smartphone, a tablet PC, etc.) or a general-purpose computer (e.g., a PC), which is capable of transmitting and receiving data to and from a server including an AI neural network over a network. For example, the server may compress an AI neural network and transmit the compressed AI neural network to a mobile device, according to a disclosed embodiment of the disclosure. The mobile device may perform a function, such as voice synthesis and image processing, by using the compressed AI neural network.

The AI neural network may be generated by learning a plurality of pieces of text data and image data that are input as training data, according to a certain criterion. The AI neural network may include a plurality of models trained to perform at least one function.

According to an embodiment of the disclosure, the electronic device 10 may include at least one hardware that compresses the AI neural network model. The at least one hardware that compresses the AI neural network model may exist in the form of a processor. The processor may include at least one generally-used processor (e.g., a central processing unit (CPU) or an application processor) and at least one processor manufactured to perform a function of compressing the AI neural network model. The general-purpose processor or the processor manufactured to perform the function of compressing the AI neural network model may compress the AI neural network model by executing at least one instruction.

The electronic device 10 may generate a compression kernel 110b by compressing respective kernels 110a of convolution layers of the AI neural network model. Each kernel 110a of the convolution layer may include a convolution tensor. The convolution tensor may mean a high-dimensionally extended matrix to which a convolution operation is applied. While three-dimensional (3D) and four-dimensional (4D) convolution tensors are described below as examples, the disclosure is not limited thereto. The compression kernel 110b may include a V kernel and a U kernel.

The electronic device 10 may generate a tile matrix by tiling a convolution tensor. For example, the electronic device 10 may generate a tile matrix by dividing a 3D convolution tensor or a 4D convolution tensor into a plurality of 2D sub-matrices and tiling a plurality of 2D sub-matrices in a certain direction. The tile matrix may mean a 2D matrix generated by tiling the plurality of sub-matrices divided from the convolution tensor in a certain direction. The sub-matrix may mean a matrix constituting the convolution tensor.

According to an embodiment of the disclosure, the electronic device 10 may tile the convolution tensor based on the shape of the convolution tensor. To improve a compression rate of the AI neural network model, the electronic device 10 may generate a tile matrix that is similar to a square matrix, by tiling a plurality of sub-matrices vertically, horizontally, or bi-directionally based on the shape of the convolution tensor. By tiling the convolution tensor in a tile matrix that is most similar to a square matrix, the convolution tensor may be compressed at a high compression rate when low rank approximation (LRA) is performed with the same rank. Alternatively or additionally, by tiling the convolution tensor in a tile matrix that is most similar to a square matrix, the convolution tensor may be compressed with high rank when LRA is performed at the same compression rate.

The electronic device 10 may identify a sharing matrix from a tile matrix. The sharing matrix may mean a matrix that is commonly operated with a plurality of matrices to form an approximated tile matrix. For example, the electronic device 10 may identify, as a sharing matrix, at least one of a U matrix or a V matrix that are commonly operated with at least some of sub-matrices when a sub-matrix Mij is expressed as a product of an i^{th} U matrix and a j^{th} V matrix.

According to an embodiment of the disclosure, the electronic device 10 may identify the sharing matrix based on a method of tiling a convolution tensor. For example, the electronic device 10 may identify at least one of a top row of a tile matrix or a left column of the tile matrix as the sharing matrix, based on the method of tiling the convolution tensor.

The electronic device 10 may generate the U matrix and the V matrix, by performing LRA on the tile matrix based on the sharing matrix. The electronic device 10 may generate a U convolution tensor by recombining the U matrix and generate a V convolution tensor by recombining the V matrix.

The electronic device 10 may perform a convolution operation on a U kernel including the U convolution tensor and a V kernel including the V convolution tensor, with input data, thereby obtaining output data.

According to an embodiment of the disclosure, by performing the convolution operation on the input data by using the V kernel and the U kernel when performing inference (voice synthesis/image processing) using an AI neural network, the electronic device 10 may obtain output data having equivalent performance as when performing the convolution operation the input data by using the kernel 110a.

Moreover, according to an embodiment of the disclosure, the electronic device 10 may maximize a compression rate of the AI neural network and reduce the amount of operations, by performing the convolution operation using the V kernel and the U kernel.

Furthermore, according to an embodiment of the disclosure, the electronic device 10 may accelerate the convolution operation by using hardware and software built properly for a convolution structure of the kernel 110a, by sequentially performing the convolution operation on the input data using the V kernel and the U kernel, instead of performing the convolution operation on the input data using the kernel 110a.

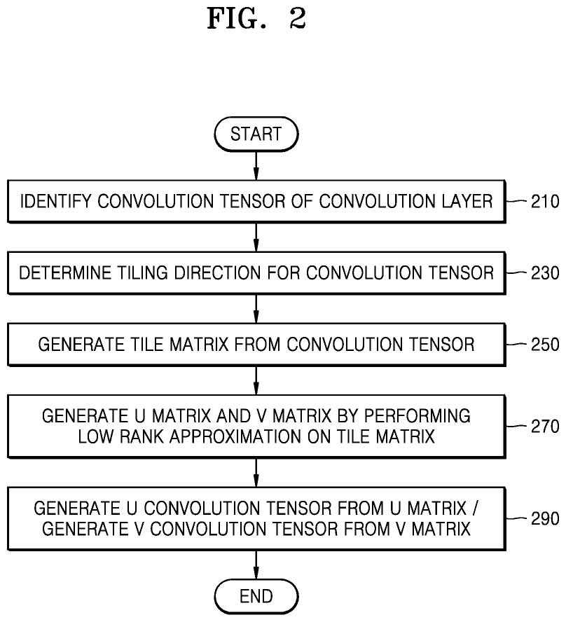

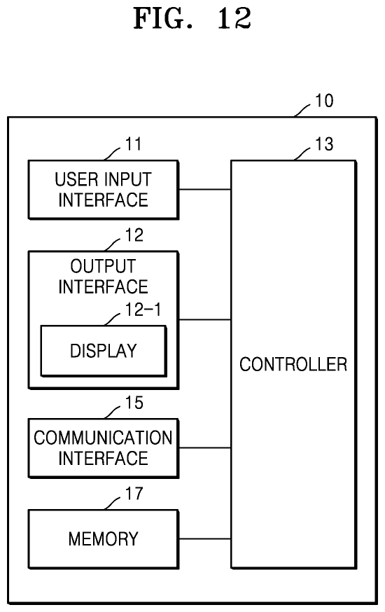

FIG. 2 is a flowchart of a method, performed by an electronic device, of compressing an AI neural network model, according to an embodiment of the disclosure. Referring to FIG. 2, the electronic device 10 may perform the method of compressing the AI neural network model, including operations 210 through 290 by a processor 13 executing at least one instruction stored in a memory 17 (shown in FIG. 12).

Referring to operation 210, the electronic device 10 may identify a convolution tensor of a convolution layer included in the AI neural network model.

According to an embodiment of the disclosure, the electronic device 10 may obtain the AI neural network model. For example, the electronic device 10 may obtain the AI neural network model by reading the AI neural network model stored in the memory 17. In another example, the electronic device 10 may obtain the AI neural network model by receiving the AI neural network model from the server.

According to an embodiment of the disclosure, the electronic device 10 may identify the convolution tensor from the AI neural network model. The electronic device 10 may identify the convolution layer of the AI neural network model and the convolution tensor included in the convolution layer, by identifying a structure of the AI neural network model. For example, the electronic device 10 may identify a 3D convolution tensor to which a one-dimensional (1D) convolution operation is applied. In another example, the electronic device 10 may identify a 4D convolution tensor to which a 2D convolution operation is applied. Generally, the AI neural network model used for voice synthesis may perform the 1D convolution operation, and the AI neural network model used for image processing may perform the 2D convolution operation.

Referring to operation 230, the electronic device 10 may determine a tiling direction for the convolution tensor. The electronic device 10 may divide the convolution tensor into a plurality of sub-matrices including rows of a size of an input channel and columns of a size of an output channel, and determine a tiling direction for the plurality of sub-matrices. The electronic device 10 may tile the plurality of sub-matrices vertically, horizontally, or bi-directionally, based on the shape of the convolution tensor, such that the tile matrix is similar to the square matrix.

According to an embodiment of the disclosure, the electronic device 10 may divide the convolution tensor into a plurality of 2D sub-matrices. For example, the electronic device 10 may divide the 3D convolution tensor into K I×O 2D matrices (where, “I” indicates a size of an input channel and “0” indicates a size of an output channel). In another example, the electronic device 10 may divide the 4D convolution tensor into Kₓ×K_{y} I×O 2D matrices.

According to an embodiment of the disclosure, the electronic device 10 may determine a tiling direction for a plurality of sub-matrices, based on at least one of a size of an input channel of a convolution tensor, a size of an output channel of the convolution tensor, the number of columns of a convolution kernel formed by the convolution tensor, or the number of rows of the convolution kernel.

For example, the electronic device 10 may determine a tiling direction for the plurality of sub-matrices divided from the 3D convolution tensor based on a result of comparing the size of the input channel of the convolution tensor with the size of the output channel of the convolution tensor. More specifically, the electronic device 10 may determine to tile the plurality of sub-matrices vertically, based on a result of the size of the input channel of the convolution kernel being less than the size of the output channel of the convolution kernel.

In addition, the electronic device 10 may determine to tile the plurality of sub-matrices horizontally, based on a result of the size of the input channel of the convolution kernel being greater than the size of the output channel of the convolution kernel.

In another example, the electronic device 10 may determine a tiling direction for the plurality of sub-matrices divided from the 4D convolution tensor based on a result of comparing a greater value between the number of columns of the convolution kernel and the number of rows of the convolution kernel with a ratio of the size of the output channel to the size of the input channel.

More specifically, the electronic device 10 may determine to tile the plurality of sub-matrices vertically, based on a result of the greater value between the number of columns of the convolution kernel and the number of rows of the convolution kernel being less than the ratio of the size of the output channel to the size of the input channel.

In addition, the electronic device 10 may determine to tile the plurality of sub-matrices horizontally, based on a result of a reciprocal of the greater value between the number of columns of the convolution kernel and the number of rows of the convolution kernel being greater than the ratio of the size of the output channel to the size of the input channel.

Furthermore, the electronic device 10 may determine to tile the plurality of sub-matrices horizontally by as many as the number of columns of the convolution kernel and vertically by as many as the number of rows of the convolution kernel, or may determine to tile the plurality of sub-matrices vertically by as many as the number of columns of the convolution kernel and horizontally by as many as the number of rows of the convolution kernel, based on a result of the greater value between the number of columns of the convolution kernel and the number of rows of the convolution kernel being greater than the ratio of the size of the output channel to the size of the input channel and the reciprocal of the greater value between the number of columns of the convolution kernel and the number of rows of the convolution kernel being less than the ratio of the size of the output channel to the size of the input channel.

Referring to operation 250, the electronic device 10 may generate a tile matrix from the convolution tensor.

According to an embodiment of the disclosure, the electronic device 10 may generate the tile matrix by tiling the plurality of 2D sub-matrices appropriately for the direction determined in operation 230.

For example, the electronic device 10 may generate a (I*K)×O tile matrix by vertically tiling I×O 2D sub-matrices divided from the 3D convolution tensor on which the 1D convolution operation is performed. The electronic device 10 may generate the I×(K*O) tile matrix by vertically tiling the I×O 2D sub-matrices.

For example, the electronic device 10 may generate a (I*Kₓ*K_{y})×O tile matrix including (I*Kₓ*K_{y}) rows and O columns by vertically tiling I×O 2D sub-matrices divided from the 4D convolution tensor on which the 2D convolution operation is performed, in which I indicates the number of input channels, O indicates the number of output channels, Kₓ indicates the number of columns of the convolution kernel, K_{y} indicates the number of rows of the convolution kernel, and I*Kₓ*K_{y} indicates a product of I, Kₓ, and K_{y}. Moreover, the electronic device 10 may generate a I×(Kₓ*K_{y}*O) tile matrix including I rows and (Kₓ*K_{y}*O) columns by horizontally tiling I×O 2D sub-matrices, in which I indicates the number of input channels, O indicates the number of output channels, Kₓ indicates the number of columns of the convolution kernel, K_{y} indicates the number of rows of the convolution kernel, and Kₓ*K_{y}*O indicates a product of Kₓ, K_{y}, and O. The electronic device 10 may generate a (I*K_{y})×(O*Kₓ) tile matrix including (I*K_{y}) rows and (O*Kₓ) columns by bi-directionally tiling the I×O 2D sub-matrices, in which I indicates the number of input channels, O indicates the number of output channels, Kₓ indicates the number of columns of the convolution kernel, K_{y} indicates the number of rows of the convolution kernel, (I*K_{y}) indicates a product of I and K_{y}, and (O*Kₓ) indicates a product of O and Kₓ. Alternatively or additionally, the electronic device 10 may generate a (I*Kₓ)×(O*K_{y}) tile matrix including (I*Kₓ) rows and (O*K_{y}) columns, in which I indicates the number of input channels, O indicates the number of output channels, Kₓ indicates the number of columns of the convolution kernel, K_{y} indicates the number of rows of the convolution kernel, (I*Kₓ) indicates a product of I and Kₓ, and (O*K_{y}) indicates a product of O and K_{y}.

Referring to operation 270, the electronic device 10 may generate a U matrix and a V matrix by performing LRA on a tile matrix. The electronic device 10 may identify a sharing matrix from a tile matrix and perform LRA on the tile matrix based on the sharing matrix.

According to an embodiment of the disclosure, the electronic device 10 may identify the sharing matrix based on the method of tiling the convolution tensor.

According to an embodiment of the disclosure, the electronic device 10 may identify the sharing matrix, based on at least one of the size of the input channel of the convolution tensor, the size of the output channel of the convolution tensor, the number of columns of the convolution kernel formed by the convolution tensor, or the number of rows of the convolution kernel.

For example, the electronic device 10 may identify the sharing matrix from the tile matrix in which the 3D convolution tensor is tiled, based on a result of comparing the size of the input channel of the convolution tensor with the size of the output channel of the convolution tensor.

More specifically, the electronic device 10 may identify a top row of the tile matrix as the sharing matrix, based on a result of the size of the input channel of the convolution kernel being less than the size of the output channel of the convolution kernel.

Moreover, the electronic device 10 may identify a left column of the tile matrix as the sharing matrix, based on a result of the size of the input channel of the convolution kernel being greater than the size of the output channel of the convolution kernel.

In another example, the electronic device 10 may identify the sharing matrix from a tile matrix in which the 4D convolution tensor is tiled, based on a result of comparing the greater value between the number of columns of the convolution kernel and the number of rows of the convolution kernel with the ratio of the size of the output channel to the size of the input channel.

More specifically, the electronic device 10 may identify the top row of the tile matrix as the sharing matrix, based on a result of the greater value between the number of columns of the convolution kernel and the number of rows of the convolution kernel being less than the ratio of the size of the output channel to the size of the input channel.

In addition, the electronic device 10 may identify the left column of the tile matrix as the sharing matrix, based on a result of the reciprocal of the greater value between the number of columns of the convolution kernel and the number of rows of the convolution kernel being greater than the ratio of the size of the output channel to the size of the input channel.

In addition, the electronic device 10 may identify the top row of the tile matrix and the left column of the tile matrix as the sharing matrix, based on a result of the greater value between the number of columns of the convolution kernel and the number of rows of the convolution kernel being greater than the ratio of the size of the output channel to the size of the input channel and the reciprocal of the greater value between the number of columns of the convolution kernel and the number of rows of the convolution kernel being less than the ratio of the size of the output channel to the size of the input channel.

The electronic device 10 may perform LRA on the tile matrix based on the identified sharing matrix. For example, the electronic device 10 may generate a 2D U matrix and a 2D V matrix by using a LRA algorithm such as an alternative least square, singular value decomposition, and a sudo inverse.

Referring to operation 290, the electronic device 10 may generate a U convolution tensor from the U matrix and a V convolution tensor from the V matrix. For example, the electronic device 10 may generate a 4D U convolution tensor by recombining the 2D U matrix and generate a 4D V convolution tensor by recombining the 2D V matrix. The generated U convolution tensor and V convolution tensor may be independent convolution kernels. The convolution operation may be performed on the U convolution tensor and the V convolution tensor while a convolution structure of the kernel 110a is maintained.

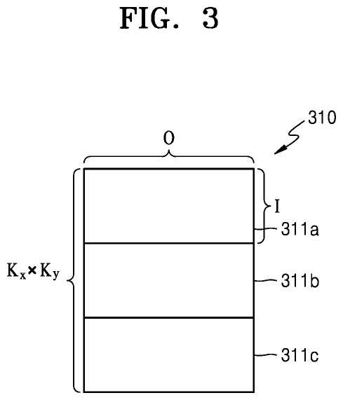

FIG. 3 is a view for describing an example of a method, performed by an electronic device, of tiling a convolution tensor, according to an embodiment of the disclosure.

Referring to FIG. 3, the electronic device 10 may determine a tiling direction for sub-matrices constituting a convolution tensor.

The electronic device 10 may vertically tile sub-matrices 311a, 311b, and 311c to generate a tile matrix 310 that is similar to a square matrix, so as to improve a compression rate of an AI neural network model.

According to an embodiment of the disclosure, the electronic device 10 may generate a (I*K)×O tile matrix by vertically tiling a plurality of sub-matrices divided from a 3D convolution tensor, based on a result of the size of the input channel of the convolution kernel being less than the size of the output channel of the convolution kernel.

According to an embodiment of the disclosure, the electronic device 10 may generate the (I*Kₓ*K_{y})×O tile matrix 310 by vertically tiling the sub-matrices 311a, 311b, and 311c divided from the 4D convolution tensor, based on a result of the greater value between the number Kₓ of columns of the convolution kernel and the number K_{y} of rows of the convolution kernel being less than the ratio of the size O of the output channel to the size I of the input channel, as shown in Equation 1. More specifically, the electronic device 10 may generate the (I*Kₓ*K_{y})×O tile matrix 310 including (I*Kₓ*K_{y}) rows and O columns by vertically tiling I×O 2D sub-matrices as many as a product of Kₓ and K_{y}, in which I indicates the number of input channels, O indicates the number of output channels, Kₓ indicates the number of columns of the convolution kernel, and K_{y} indicates the number of rows of the convolution kernel.

$$\frac{O}{I} \geq max ( {K}_{x} , {K}_{y} ) \qquad [ Equation 1 ]$$

O indicates the size of the output channel, I indicates the size of the input channel, Kₓ indicates the number of columns of the convolution kernel, K_{y} indicates the number of rows of the convolution kernel, and max(Kₓ, K_{y}) indicates a maximum value between the number of columns of the convolution kernel Kₓ and the number of rows of the convolution kernel K_{y}.

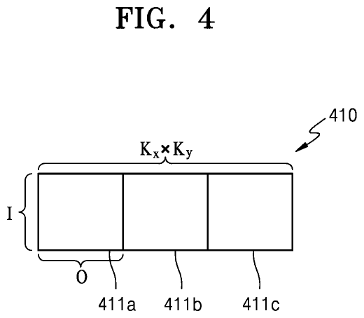

FIG. 4 is a view for describing an example of a method, performed by an electronic device, of tiling a convolution tensor, according to an embodiment of the disclosure.

Referring to FIG. 4, the electronic device 10 may horizontally tile sub-matrices 411a, 411b, and 411c to generate a tile matrix 410 that is similar to a square matrix, so as to improve a compression rate of an AI neural network model.

According to an embodiment of the disclosure, the electronic device 10 may generate a I×(K*O) tile matrix by horizontally tiling a plurality of sub-matrices divided from a 3D convolution tensor, based on a result of the size of the input channel of the convolution kernel being greater than the size of the output channel of the convolution kernel.

According to an embodiment of the disclosure, the electronic device 10 may generate a I×(Kₓ*K_{y}*O) tile matrix 410 by horizontally tiling the sub-matrices 411a, 411b, and 411c divided from the 4D convolution tensor, based on a result of the reciprocal of the greater value between the number Kₓ of columns of the convolution kernel and the number K_{y} of rows of the convolution kernel being greater than the ratio of the size O of the output channel to the size I of the input channel, as shown in Equation 2. More specifically, the electronic device 10 may generate the I×(Kₓ*K_{y}*O) tile matrix 410 by horizontally tiling I×O 2D sub-matrices as many as a product of Kₓ and K_{y}, in which I indicates the number of input channels, O indicates the number of output channels, Kₓ indicates the number of columns of the convolution kernel, and K_{y} indicates the number of rows of the convolution kernel.

$$\frac{O}{I} \leq \frac{1}{max ( {K}_{x} , {K}_{y} )} \qquad [ Equation 2 ]$$

O indicates the size of the output channel, I indicates the size of the input channel, Kₓ indicates the number of columns of the convolution kernel, K_{y} indicates the number of rows of the convolution kernel, and max(Kₓ, K_{y}) indicates a maximum value between the number of columns of the convolution kernel and the number of rows of the convolution kernel.

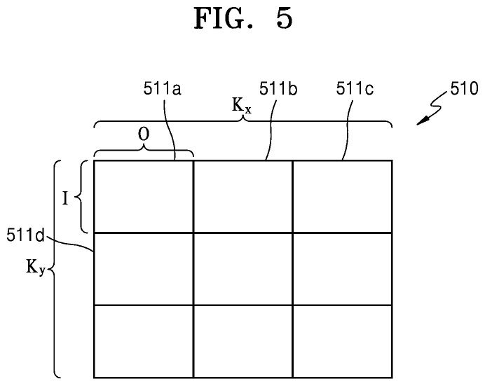

FIG. 5 is a view for describing an example of a method, performed by an electronic device, of tiling a convolution tensor, according to an embodiment of the disclosure.

Referring to FIG. 5, the electronic device 10 may bi-directionally tile sub-matrices 511a, 511b, 511c, and 511d to generate a tile matrix 510 that is similar to a square matrix, so as to improve a compression rate of an AI neural network model.

According to an embodiment of the disclosure, the electronic device 10 may generate the (I*K_{y})×(O*Kₓ) or (I*Kₓ)×(O*K_{y}) tile matrix 510 by bi-directionally tiling the sub-matrices 511a, 511b, 511c, and 511d divided from the 4D convolution tensor, based on a result of the greater value between the number of columns of the convolution kernel and the number of rows of the convolution kernel being greater than the ratio of the size of the output channel to the size of the input channel, and the reciprocal of the greater value between the number of columns of the convolution kernel and the number of rows of the convolution kernel being less than the ratio of the size of the output channel to the size of the input channel. More specifically, the electronic device 10 may generate a (I*K_{y})×(O*Kₓ) tile matrix by tiling the I×O 2D sub-matrices horizontally by as many as Kₓ and vertically by as many as K_{y}. Alternatively or additionally, the electronic device 10 may generate a (I*Kₓ)×(O*K_{y}) tile matrix by tiling the I×O 2D sub-matrices horizontally as many as K_{y} and vertically as many as Kₓ. The electronic device 10 may select a matrix that is more similar to a square matrix between a (I*K_{y})×(O*Kₓ) tile matrix and a (I*Kₓ)×(O*K_{y}) tile matrix and use the selected matrix to generate a U matrix and a V matrix.

According to an embodiment of the disclosure, the electronic device 10 may generate the tile matrix 510 by horizontally tiling the sub-matrices 511a, 511b, and 511c as many as the number Kₓ of columns of the convolution kernel, and then horizontally tiling the sub-matrix 511d from the beginning of the next row, as shown in Equation 3.

$$\frac{1}{max ( {K}_{x} , {K}_{y} )} \leq \frac{O}{I} \leq max ( {K}_{x} , {K}_{y} ) \qquad [ Equation 3 ]$$

O indicates the size of the output channel, I indicates the size of the input channel, Kₓ indicates the number of columns of the convolution kernel, K_{y} indicates the number of rows of the convolution kernel, and max(Kₓ, K_{y}) indicates the maximum value between the number of columns of the convolution kernel and the number of rows of the convolution kernel.

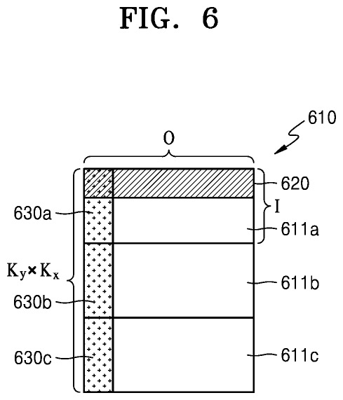

FIGS. 6 through 8 are views for describing an example of a method, performed by an electronic device, of identifying a sharing matrix from a tile matrix, according to an embodiment of the disclosure.

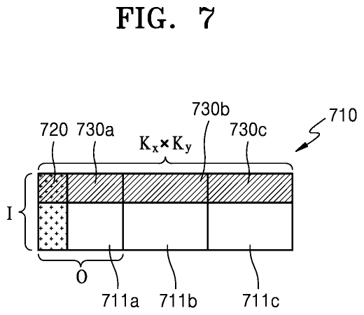

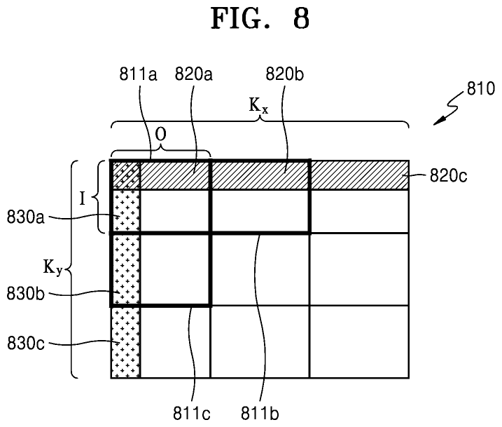

More specifically, FIG. 6 is a view for describing identifying a top row 620 of a tile matrix 610 as a sharing matrix, FIG. 7 is a view for describing a method of performing LRA by identifying a left column 720 of a tile matrix 710 as a sharing matrix, and FIG. 8 is a view for describing a method of performing LRA by identifying top rows 820a, 820b, and 820c and left columns 830a, 830b, and 830c of a tile matrix 810.

Sub-matrices constituting a tile matrix may be expressed as a product of a row and a column of the tile matrix. For example, the sub-matrix Mij of the tile matrix 610 may be expressed as a product of an i^{th} U matrix Ui and a j^{th} V matrix Vj.

The electronic device 10 may identify the sharing matrix, which is a matrix commonly operated in expression of the sub-matrices, from the tile matrix. The electronic device 10 may maximize a compression rate of an AI neural network and reduce the amount of operations while maintaining the convolution structure of the kernel 110a, by performing LRA using the sharing matrix.

According to an embodiment of the disclosure, the electronic device 10 may identify the sharing matrix from the tile matrix, based on a tiling direction for sub-matrices. For example, the electronic device 10 may identify a top row of a tile matrix as a sharing matrix based on sub-matrices being tiled vertically. In another example, the electronic device 10 may identify a left column of the tile matrix as the sharing matrix based on the sub-matrices being tiled horizontally. In another example, the electronic device 10 may identify the top row and the left column of the tile matrix as the sharing matrix based on the sub-matrices being tiled bi-directionally.

Referring to FIG. 6, the electronic device 10 may generate the tile matrix 610 by vertically tiling the sub-matrices 611a, 611b, and 611c divided from the 4D convolution tensor, based on a result of the greater value between the number Kₓ of columns of the convolution kernel and the number K_{y} of rows of the convolution kernel being less than the ratio of the size O of the output channel to the size I of the input channel.

The sub-matrix 611a may be expressed as a product of the top row 620 of the tile matrix 610 and a left column 630a of the tile matrix 610, the sub-matrix 611b may be expressed as a product of the top row 620 of the tile matrix 610 and a left column 630b of the tile matrix 610, and the sub-matrix 611c may be expressed as a product of the top row 620 of the tile matrix 610 and a left column 630c of the tile matrix 610. That is, by multiplying the top row 620 of the tile matrix 610 to each of the left columns 630a, 630b, and 630c of the tile matrix 610, the sub-matrices 611a, 611b, and 611c may be obtained respectively.

Thus, the top row 620 of the tile matrix 610 may be a matrix commonly operated to express the sub-matrices 611a, 611b, and 611c, such that the electronic device 10 may identify the top row 620 of the tile matrix 610 as the sharing matrix, based on the sub-matrices 611a, 611b, and 611c being tiled vertically.

More specifically, the electronic device 10 may identify a top row of a tile matrix, generated by vertically tiling the 3D convolution tensor, as a sharing matrix, based on a result of the size of the input channel of the convolution kernel being less than the size of the output channel of the convolution kernel.

Referring to FIG. 7, the electronic device 10 may generate the tile matrix 710 by horizontally tiling the sub-matrices 711a, 711b, and 711c divided from the 4D convolution tensor, based on a result of the reciprocal of the greater value between the number Kₓ of columns of the convolution kernel and the number K_{y} of rows of the convolution kernel being greater than the ratio of the size O of the output channel to the size I of the input channel.

The sub-matrix 711a may be expressed as a product of a top row 730a of the tile matrix 710 and the left column 720 of the tile matrix 710, the sub-matrix 711b may be expressed as a product of a top row 730b of the tile matrix 710 and the left column 720 of the tile matrix 710, and the sub-matrix 711c may be expressed as a product of a top row 730c of the tile matrix 710 and the left column 720 of the tile matrix 710. That is, by multiplying the left column 720 of the tile matrix 710 to each of the top rows 730a, 730b, and 730c of the tile matrix 710, the sub-matrices 711a, 711b, and 711c may be obtained respectively.

Thus, the left column 720 of the tile matrix 710 may be a matrix commonly operated to express the sub-matrices 711a, 711b, and 711c, such that the electronic device 10 may identify the left column 720 of the tile matrix 710 as the sharing matrix, based on the sub-matrices 711a, 711b, and 711c being tiled horizontally.

In addition, the electronic device 10 may identify a left column of a tile matrix, generated by horizontally tiling a 3D convolution tensor, as a sharing matrix, based on a result of the size of the input channel of the convolution kernel being greater than the size of the output channel of the convolution kernel.

Referring to FIG. 8, the electronic device 10 may generate the tile matrix 810 by bi-directionally tiling the sub-matrices 811a, 811b, and 811c divided from the 4D convolution tensor, based on a result of the greater value between the number Kₓ of columns of the convolution kernel and the number K_{y} of rows of the convolution kernel being greater than the ratio of the size O of the output channel to the size I of the input channel and the reciprocal of the greater value between the number Kₓ of columns of the convolution kernel and the number K_{y} of rows of the convolution kernel being less than the ratio of the size O of the output channel to the size I of the input channel.

The sub-matrix 811a may be expressed as a product of a top row 820a of the tile matrix 810 and the left column 830a of the tile matrix 810, the sub-matrix 811b may be expressed as a product of a top row 820b of the tile matrix 810 and the left column 830a of the tile matrix 810, and the sub-matrix 811c may be expressed as a product of the top row 820a of the tile matrix 810 and the left column 830b of the tile matrix 810. That is, by multiplying the left columns 830a, 830b, and 830c of the tile matrix 810 to each of the top rows 820a, 820b, and 820c of the tile matrix 810, the sub-matrices may be obtained respectively.

Thus, the top rows 820a, 820b, and 820c of the tile matrix 810 and the left columns 830a, 830b, and 830c of the tile matrix 810 are matrices commonly operated to express sub-matrices of the tile matrix 810, such that the electronic device 10 may identify the top rows 820a, 820b, and 820c of the tile matrix 810 and the left columns 830a, 830b, and 830c of the tile matrix 810 as a sharing matrix based on the sub-matrices being tiled bidirectionally.

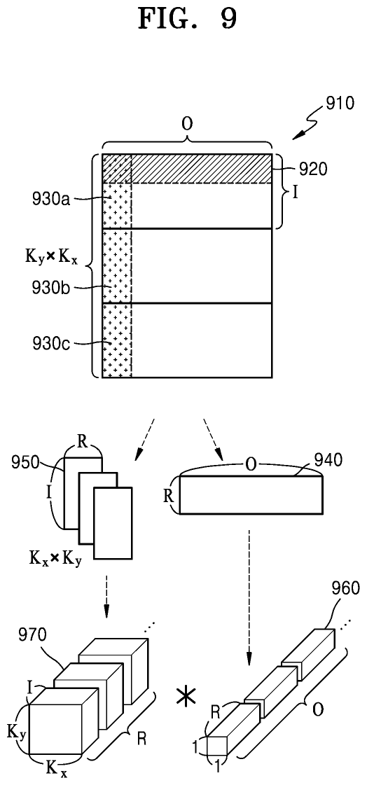

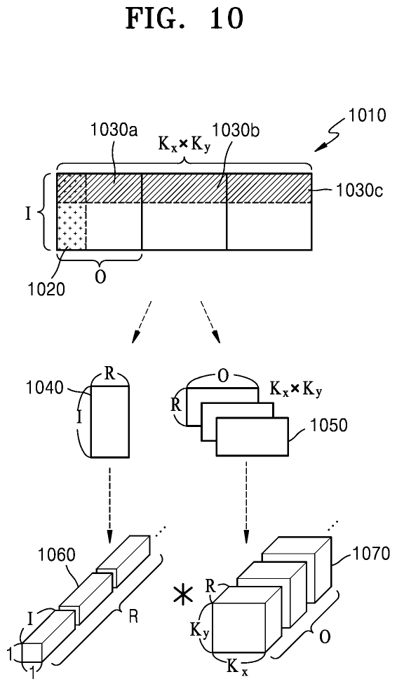

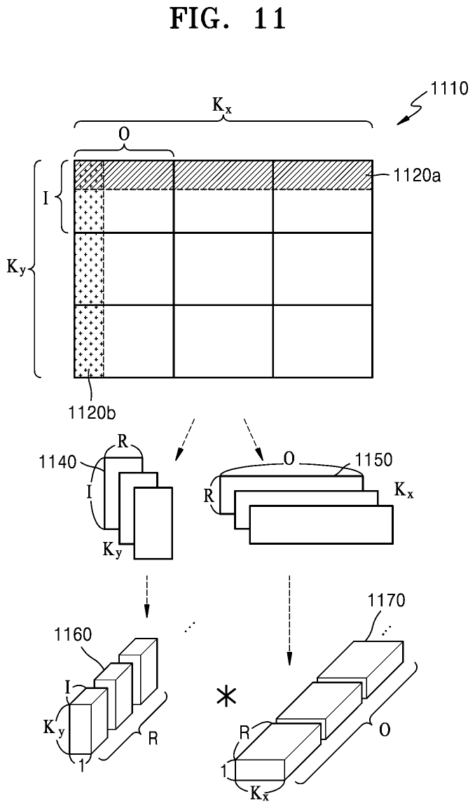

FIGS. 9 through 11 are views for describing examples of various methods, performed by an electronic device, of generating a U matrix and a V matrix by using a sharing matrix, according to an embodiment of the disclosure. More specifically, FIG. 9 is a view for describing a method of performing LRA by identifying a top row 920 of a tile matrix 910 as a sharing matrix, FIG. 10 is a view for describing a method of performing LRA by identifying a left column 1020 of a tile matrix 1010 as a sharing matrix, and FIG. 11 is a view for describing a method of performing LRA by identifying a top row 1020a and a left column 1020b of a tile matrix 1110 as a sharing matrix.

The electronic device 10 may obtain an MR 2D matrix and an RN 2D matrix, by performing LRA based on an MN 2D matrix. That is, the electronic device 10 may obtain a U matrix and a V matrix by performing LRA on a tile matrix.

The electronic device 10 may perform LRA by using the sharing matrix to maximize a compression rate of an AI neural network and reduce the amount of operations while maintaining a convolution structure of the kernel 110a.

Referring to FIG. 9, the electronic device 10 may perform LRA by identifying the top row 920 of the tile matrix 910 as a sharing matrix. The electronic device 10 may obtain an Rx O U matrix 940 and Kₓ*K_{y} I×R V matrices 950 by performing LRA on the tile matrix 910. The electronic device 10 may obtain the U matrix 940 from the top row 920 of the tile matrix 910, which is the sharing matrix. In addition, the electronic device 10 may obtain the V matrix 950 from left columns 930a, 930b, and 930c of the tile matrix 910, multiplied by the sharing matrix.

Referring to FIG. 10, the electronic device 10 may perform LRA by identifying the left column 1020 of the tile matrix 1010 as the sharing matrix. The electronic device 10 may obtain an I×R V matrix 1040 and Kₓ*K_{y} R×O U matrices 1050 by performing LRA on the tile matrix 1010. The electronic device 10 may obtain the V matrix 1040 from the left column 1020 of the tile matrix 1010, which is the sharing matrix. In addition, the electronic device 10 may obtain the U matrices 1050 from top rows 1030a, 1030b, and 1030c of the tile matrix 1010, multiplied by the sharing matrix.

Referring to FIG. 11, the electronic device 10 may perform LRA by identifying a top row 1120a and a left column 1120b of the tile matrix 1110 as the sharing matrix. The electronic device 10 may obtain K_{y} I×R V matrices 1140 and Kₓ R×O U matrices 1150 by performing LRA on the tile matrix 1110. The electronic device 10 may obtain the V matrices 1140 from the left columns 1120b of the tile matrix 1010, which correspond to a sharing matrix. The electronic device 10 may obtain the U matrix 1150 from the top rows 1120a of the tile matrix 1010, which correspond to the sharing matrix.

In addition, the electronic device 10 may generate the U convolution tensors 960, 1070, and 1170 by recombining the U matrices 940, 1050, and 1150, and generate the V convolution tensors 970, 1060, and 1160 by recombining the V matrices 950, 1040, and 1140. For example, the electronic device 10 may generate the U convolution tensors 960, 1070, and 1170 and the V convolution tensors 970, 1060, and 1160 by combining the U matrices 940, 1050, and 1150 and the V matrices 950, 1040, and 1140 in an order that is reverse to the order of dividing a convolution tensor into a plurality of 2D sub-matrices.

Referring to Equations 4 through 24, a convolution operation structure of the U convolution tensors 960, 1070, and 1170 and the V convolution tensors 970, 1060, and 1160 may be maintained. The electronic device 10 may perform a convolution operation on input data, the U convolution tensors 960, 1070, and 1170, and the V convolution tensors 970, 1060, and 1160, by using hardware and software designed and established to perform the convolution operation.

The convolution operation may be expressed as shown in Equation 4 below. That is, the electronic device 10 may speed up an operation having a structure as shown in Equation 4, by using hardware and software.

$${Y}_{o} ( t , s ) = {\sum }_{{k}_{t}} {\sum }_{{k}_{s}} {W}_{o \times i}^{( {k}_{t} , {k}_{s} )} X ( f - {k}_{t} , s - {k}_{s} ) \qquad [ Equation 4 ]$$

o indicates a size of an output channel, i indicates a size of an input channel, kₜ and kₛ indicate kernel indices, W indicates a 4D convolution tensor, and Yₒ indicates an output value of a convolution operation result.

The W convolution tensor of Equation 4 may be approximated to the U convolution tensor and the V convolution tensor as shown in Equation 5.

W_{o×i}^{(k}^{ₜ}^{,k}^{ₛ}⁾≈U_{o×r}^{(k}^{ₜ}^{,k}^{ₛ}⁾V_{r×i}^{(k}^{ₜ}^{,k}^{ₛ}⁾ [Equation 5]

When Equation 5 is applied to Equation 4, Equation 4 may be expressed as Equation 6.

$${Y}_{o} ( t , s ) = {\sum }_{{k}_{t}} {\sum }_{{k}_{s}} {U}_{o \times r}^{( {k}_{t} , {k}_{s} )} {V}_{r \times i}^{( {k}_{t} , {k}_{s} )} {X}_{i} ( t - {k}_{t} , s - {k}_{s} ) \qquad [ Equation 6 ]$$

Equation 6 is expressed based on the approximated U convolution tensor and the V convolution tensor based on Equation 4. That is, when the W convolution tensor is replaced with the convolution tensor U and the convolution tensor V, the electronic device 10 may accelerate the convolution operation by using hardware and software.

In addition, when the electronic device 10 identifies a left column of a tile matrix as a sharing matrix, the W convolution tensor of Equation 4 may be approximated to the U convolution tensor and the V convolution tensor as shown in Equation 7.

W_{o×i}^{(k}^{ₜ}^{,k}^{ₛ}⁾≈U_{o×r}¹V_{r×i}^{(k}^{ₜ}^{,k}^{ₛ}⁾ [Equation 7]

When Equation 7 is applied to Equation 4, Equation 4 may be expressed as Equation 8.

$${Y}_{o} ( t , s ) = {\sum }_{{k}_{t}} {\sum }_{{k}_{s}} {U}_{o \times r}^{1} {V}_{r \times i}^{( {k}_{t} , {k}_{s} )} {X}_{i} ( t - {k}_{t} , s - {k}_{s} ) \qquad [ Equation 8 ]$$

In addition, the U convolution tensor of Equation 8 is irrelevant to kernel indices kₜ and kₛ, such that Equation 8 may be expressed as Equation 9.

$${Y}_{o} ( t , s ) = {U}_{o \times r}^{1} {\sum }_{{k}_{t}} {\sum }_{{k}_{s}} {V}_{r \times i}^{( {k}_{t} , {k}_{s} )} {X}_{i} ( t - {k}_{t} , s - {k}_{s} ) \qquad [ Equation 9 ]$$

Here, Lᵣ having a convolution operation structure may be defined as shown in Equation 10 below.

$${L}_{r} ( t , s ) = {\sum }_{{k}_{t}}^{1} {\sum }_{{k}_{s}}^{1} {V}_{r \times i}^{( {k}_{t} , {k}_{s} )} {X}_{i} ( t - {k}_{t} , s - {k}_{s} ) \qquad [ Equation 10 ]$$

When Equation 10 is applied to Equation 9, Equation 10 may be expressed as Equation 11.

Yₒ(t,s)=U_{o×r}¹Lᵣ(t,s) [Equation 11]

In addition, Equation 11 may be expressed as Equation 12.

$${Y}_{o} ( t , s ) = {\sum }_{k {′}_{t}}^{1} {\sum }_{k {′}_{s}}^{1} {U}_{o \times r}^{k {′}_{t} , k {′}_{s}} {L}_{r} ( t - {k}_{t}^{′} , s - {k}_{s}^{′} ) \qquad [ Equation 12 ]$$

Equation 12 is expressed based on the structure shown in Equation 4. Thus, when the left column of the tile matrix is identified as the sharing matrix, the electronic device 10 may speed up the convolution operation by using hardware and software.

Moreover, when the electronic device 10 identifies a left column of a tile matrix as a sharing matrix, the W convolution tensor of Equation 4 may be approximated to the U convolution tensor and the V convolution tensor as shown in Equation 13.

W_{o×i}^{(k}^{ₜ}^{,k}^{ₛ}⁾≈U_{o×r}^{(k}^{ₜ}^{,k}^{ₛ}⁾V_{r×i}¹ [Equation 13]

When Equation 13 is applied to Equation 4, Equation 4 may be expressed as Equation 14.

$${Y}_{o} ( t , s ) = {\sum }_{{k}_{t}} {\sum }_{{k}_{s}} {U}_{o \times r}^{( {k}_{t} , {k}_{s} )} {V}_{r \times i}^{1} {X}_{i} ( t - {k}_{t} , s - {k}_{s} ) \qquad [ Equation 14 ]$$

Here, Lᵣ may be defined as shown in Equation 15.

Lᵣ(t,s)=V_{r×i}¹Xₜ(t,s) [Equation 15]

When Equation 15 is applied to Equation 14, Equation 14 may be expressed as Equation 16.

$${Y}_{o} ( t , s ) = {\sum }_{{k}_{t}} {\sum }_{{k}_{s}} {U}_{o \times r}^{{k}_{t} , {k}_{s}} {L}_{r} ( t - {k}_{t} , s - {k}_{s} ) \qquad [ Equation 16 ]$$

Equation 16 is expressed as the structure shown in Equation 4, and Equation 15 may be expressed as Equation 17.

$${L}_{r} ( t , s ) = {\sum }_{{k}_{t}}^{1} {\sum }_{{k}_{s}}^{1} {V}_{r \times i}^{( k {′}_{t} , k {′}_{s} )} {X}_{i} ( t - {k}_{t}^{′} , s - {k}_{s}^{′} ) \qquad [ Equation 17 ]$$

Equation 17 is expressed as the structure shown in Equation 4.

That is, Equations 16 and 17 are expressed as the structure shown in Equation 4. Thus, when the top row of the tile matrix is identified as the sharing matrix, the electronic device 10 may speed up the convolution operation by using hardware and software.

When the electronic device 10 identifies the left column and the top row of the tile matrix as the sharing matrix, the W convolution tensor of Equation 4 may be approximated to the U convolution tensor and the V convolution tensor as shown in Equation 18.

$${W}_{o \times i}^{( {k}_{t} , {k}_{s} )} \approx {\sum }_{r} {U}_{o \times r}^{( {k}_{t} , 1 )} {V}_{r \times i}^{( 1 , {k}_{s} )} \qquad [ Equation 18 ]$$

When Equation 18 is applied to Equation 4, Equation 4 may be expressed as Equation 19.

$${Y}_{o} ( t , s ) = {\sum }_{{k}_{t}} {\sum }_{{k}_{s}} {U}_{o \times r}^{( {k}_{t} , 1 )} {V}_{r \times i}^{( 1 , {k}_{s} )} {X}_{i} ( t - {k}_{t} , s - {k}_{s} ) \qquad [ Equation 19 ]$$

In addition, the U convolution tensor of Equation 19 is irrelevant to the kernel index kₛ, such that Equation 19 may be expressed as Equation 20.

$${Y}_{o} ( t , s ) = {\sum }_{{k}_{t}} {U}_{o \times r}^{( {k}_{t} , 1 )} {\sum }_{{k}_{s}} {V}_{r \times i}^{( 1 , {k}_{s} )} {X}_{i} ( t - {k}_{t} , s - {k}_{s} ) \qquad [ Equation 20 ]$$

Here, Lᵣ may be defined as shown in Equation 21 below.

$${L}_{r} ( t , s ) = {\sum }_{{k}_{s}} {V}_{r \times i}^{( 1 , {k}_{s} )} {X}_{i} ( t , s - {k}_{s} ) \qquad [ Equation 21 ]$$

When Equation 21 is applied to Equation 20, Equation 20 may be expressed as Equation 22.

$${Y}_{o} ( t , s ) = {\sum }_{{k}_{t}} {U}_{o \times r}^{( {k}_{t} , 1 )} {L}_{r} ( t - {k}_{t} , s ) \qquad [ Equation 22 ]$$

In addition, Equation 22 may be expressed as Equation 23.

$${Y}_{o} ( t , s ) = {\sum }_{{k}_{t}} {\sum }_{k {′}_{s}}^{1} {U}_{o \times r}^{( {k}_{t} , {k}_{s}^{′} )} {L}_{r} ( t - {k}_{t} , s - {k}_{s}^{′} ) \qquad [ Equation 23 ]$$

Equation 23 is expressed as the structure shown in Equation 4. Meanwhile, Equation 21 may be expressed as Equation 24.

$${L}_{r} ( t , s ) = {\sum }_{k {′}_{t}}^{1} {\sum }_{{k}_{s}} {V}_{r \times i}^{( {k}_{t}^{′} , {k}_{s} )} {X}_{i} ( t - {k}_{t}^{′} , s - {k}_{s} ) \qquad [ Equation 24 ]$$

Equation 24 is expressed as the structure shown in Equation 4.

That is, Equations 23 and 24 are expressed as the structure shown in Equation 4, thus maintaining the convolution operation structure. That is, when the left column and the top row of the tile matrix are identified as the sharing matrix, the electronic device 10 may speed up the convolution operation by using hardware and software.

By performing the convolution operation on the V convolution tensors 970, 1060, and 1160 and the U convolution tensors 960, 1070, and 1170, the electronic device 10 may maximize a compression rate of an AI neural network and reduce the amount of convolutional operations.

More specifically, a first case where a convolution layer is not compressed, a second case where existing LRA is performed, a third case where LRA is performed according to embodiments of FIGS. 3, 6, and 9, a fourth case where LRA is performed according to embodiments of FIGS. 4, 7, and 10, and a fifth case where LRA is performed according to embodiments of FIGS. 5, 8, and 11, a kernel size and a convolution operation amount MACs are shown in Table 1.

TABLE 1

| | Kernel Size | Convolution Operation Amount |
|---|---|---|
| First Case | I × Kₓ × K_{y} × O | T × S × I × Kₓ × K_{y} × O |
| Second Case | R × Kₓ × K_{y} × (I + O) | R × T × S × Kₓ × K_{y} × (I + O) |
| Third Case | R × (I × Kₓ × K_{y} + O) | R × T × S (I × Kₓ × K_{y}+ O) |
| Fourth Case | R × (I + O × Kₓ × K_{y}) | R × T × S (I + O × Kₓ × K_{y}) |
| Fifth Case | R × (I × Kₓ + O × K_{y}) | R × T × S (I × Kₓ + O × K_{y}) |

Herein, R indicates a rank, I indicates a size of an input channel, O indicates a size of an output channel, Kₓ indicates the number of columns of a convolution kernel, K_{y} indicates the number of rows of the convolution kernel, S indicates a height of an input, and T indicates a width of the input.

When an 1D convolution layer of a text-to-speech (TTS) voice synthesis model is compressed in which T is 250, I is 512, O is 1024, Kₓ is 3, K_{y} is 1, and R is 128, a kernel size and a convolution computation amount of each of the first case through the fourth case may be compared as shown in Table 2.

TABLE 2

| | Kernel Size | | Convolution Operation Amount | |
|---|---|---|---|---|
| First Case | 512 * 3 * 1 * 1024 = | 1,572,864 | 250 * 512 * 3 * 1 * 1024 = | 393,216,000 |
| Second Case | 128 * 3 * 1 * (512 + 1024) = | 589,824 | 128 * 250 * 3 * 1 * (512 + 1024) = | 147,456,000 |
| Third Case | 128 * (512 * 3 * 1 + 1024) = | 327,680 | 128 * 250 * (512 * 3 * 1 + 1024) = | 81,920,000 |
| Fourth Case | 128 * (512 + 1024 * 3 * 1) = | 458,752 | 128 * 250 * (512 + 1024 * 3 * 1) = | 114,688,000 |

The third case is a case where a 3D convolution tensor is divided for vertical tiling and a top row of a tile matrix is identified as a sharing matrix for execution of LRA. The fourth case is a case where the 3D convolution tensor is divided for horizontal tiling and a left column of a tile matrix is identified as a sharing matrix for execution of LRA.

The size O of an output channel may be greater than the size I of an input channel. Thus, it may be seen that in the third case, a kernel size is smaller than and a convolution computation amount is less than those in the other cases. In particular, when the third case is compared with the first case, the kernel size and the convolution operation amount of the first case may be 4.8 times greater than those of the third case, respectively. In addition, when the third case is compared with the second case, the kernel size and the convolution operation amount of the second case may be 2.7 times greater than those of the third case, respectively.

When a 2D convolution layer of an image processing model is compressed where T is 256, S is 256, I is 512, O is 1024, Kₓ is 3, K_{y} is 3, and R is 128,

a kernel size and a convolution operation amount of each of the first case through the fifth case may be compared as shown in Table 3.

TABLE 3

| | Kernel Size | | Convolution Operation Amount | |
|---|---|---|---|---|
| First Case | 512 * 3 * 3 * 1024 = | 4,718,592 | 256 * 256 * 512 * 3 * 3 * 1024 = | 309,237,645,312 |
| Second Case | 128 * 3 * 3 * (512 + 1024) = | 1,769,472 | 128 * 256 * 256 * 3 * 3 * (512 + 1024) = | 115,964,116,992 |
| Third Case | 128 * (512 * 3 * 3 + 1024) = | 720,896 | 128 * 256 * 256 * (512 * 3 * 3 + 1024) = | 47,244,640,256 |
| Fourth Case | 128 * (512 + 1024 * 3 * 3) = | 1,245,184 | 128 * 256 * 256 * (512 + 1024 * 3 * 3) = | 81,604,378,624 |
| Fifth Case | 128 * (512 * 3 + 1024 * 3) = | 589,824 | 128 * 256 * 256 * (512 * 3 + 1024 * 3) = | 38,654,705,664 |

The greater value (Kₓ=3) between the number Kₓ of columns of the convolution kernel and the number K_{y} of rows of the convolution kernel may be greater than the ratio (1024/512=2) of the size O of the output channel to the size I of the input channel. Moreover, the reciprocal of the greater value (Kₓ=3) between the number Kₓ of columns of the convolution kernel and the number K_{y} of rows of the convolution kernel may be less than columns the ratio (1024/512=2) of the size O of the output channel to the size I of the input channel.

Thus, it may be seen that in the fifth case, the kernel size is smaller than and the convolution operation amount is less than those in the other cases. In particular, when the fifth case is compared with the first case, the kernel size and the convolution operation amount of the first case may be 8 times different from those of the fifth case, respectively.

Thus, as shown in a disclosed embodiment of the disclosure, when LRA is performed using a sharing matrix identified from a tile matrix, a kernel size and a convolution operation amount may be reduced.

FIG. 12 is a block diagram of an electronic device according to an embodiment of the disclosure.

Referring to FIG. 12, the electronic device 10 may include a user input interface 11, an output interface 12, a processor 13, a communication interface 15, and a memory 17. However, the one or more embodiments of the disclosure are not limited thereto, and more or less components than those shown in FIG. 12 may be used to implement the electronic device 10.

The user input interface 11 may be an interface through which a user inputs data for controlling the electronic device 10. For example, the user input interface 11 may include, but not limited to, a keypad, a dome switch, a touch pad (a capacitive overlay type, a resistive overlay type, an infrared beam type, a surface acoustic wave type, an integral strain gauge type, a piezoelectric effect type, etc.), a touch screen, a jog wheel, a jog switch, etc.

The user input interface 11 may receive a user input required for the electronic device 10 to carry out embodiments of the disclosure described with reference to FIGS. 1 through 11.

The output interface 12 may output information processed by the electronic device 10. The output interface 12 may output information related to the embodiments of the disclosure described with reference to FIGS. 1 through 11. For example, the output interface 12 may include a display 12-1 that outputs a notification regarding a result of compressing an AI neural network model.

The processor 13 may control overall operations of the electronic device 10. For example, the processor 13 may control operations of each of the user input interface 11, the output interface 12, the communication interface 15, the memory 17, etc., by executing at least one instruction stored in the memory 17. For example, the processor 13 may control the communication interface 15 to transmit and receive data to and from an external device (e.g., a server).

The processor 13 may be at least one processor used for a general purpose. In addition, the processor 13 may include at least one processor manufactured to compress an AI neural network model.

The processor 13 may perform the function of the AI neural network described above with reference to FIGS. 1 through 10, by executing a software module stored in the memory 17.

For example, the processor 13 may identify a convolution tensor included in a convolution layer of an AI neural network model from a structure of the AI neural network model stored in the memory 17 or received from the server, by executing a convolution tensor identifying module 17a. Matters redundant to the embodiments of the disclosure described with reference to FIGS. 1 through 11 will be omitted.

In another example, the processor 13 may determine a tiling direction for a plurality of sub-matrices based on a size of an input channel of a convolution tensor, a size of an output channel of the convolution tensor, the number of columns of a convolution kernel formed by the convolution tensor, or the number of rows of the convolution kernel by executing a tiling direction determining module 17b. Matters redundant to the embodiments of the disclosure described with reference to FIGS. 1 through 11 will be omitted.

In another example, the processor 13 may generate a tile matrix by tiling a plurality of 2D sub-matrices in a determined direction (e.g., vertically, horizontally, or bi-directionally), by executing a tile matrix generating module 17c. Detailed descriptions of the one or more embodiments are provided above with reference to FIGS. 1 through 11, therefore repeated descriptions thereof will be omitted.

In another example, the processor 13 may identify a sharing matrix from a tile matrix and perform LRA on the tile matrix based on the sharing matrix to generate a U matrix and a V matrix, by executing a LRA executing module 17d. Detailed descriptions of the embodiments of the disclosure that have been described above with reference to FIGS. 1 through 11 will be omitted.

In another example, the processor 13 may generate a U convolution tensor by recombining a U matrix and generate a V convolution tensor by recombining a V matrix, by executing a U convolution tensor/V convolution tensor generating module 17e. Detailed descriptions of the embodiments of the disclosure described above with reference to FIGS. 1 through 11 will be omitted.

The communication interface 15 may include one or more elements that enable the electronic device 10 to communicate with another device (e.g., a server). The other device (not shown) may be, but not limited to, a computing device such as the electronic device 10.

The memory 17 may store at least one instruction and at least one program for processing and control by the processor 13, and store data input to or output from the electronic device 10.

The memory 17 may include a storage medium of at least one type of memory that temporarily stores data, such as random access memory (RAM) and static random access memory (SRAM), or a data storage that non-temporarily stores data, such as a flash memory type, a hard disk type, a multimedia card micro type, a card type memory (e.g., a secure digital (SD) or extreme digital (XD) memory, etc.), read-only memory (ROM), electrically erasable programmable read-only memory (EEPROM), programmable read-only memory (PROM), magnetic memory, a magnetic disk, an optical disk, etc.

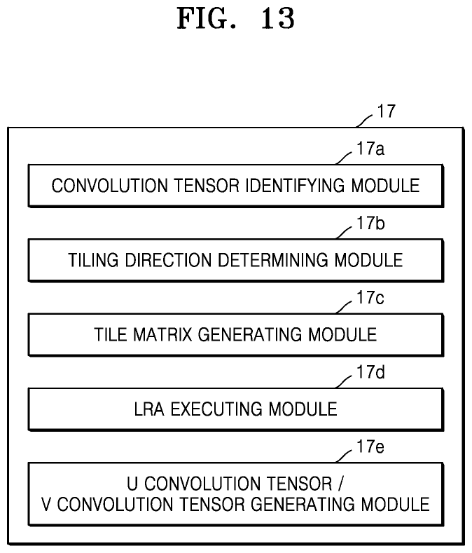

FIG. 13 is a block diagram of a software module of a memory included in an electronic device, according to an embodiment of the disclosure.

Referring to FIG. 13, the memory 17 may include, as software modules including an instruction for the electronic device 10 to perform the embodiments of the disclosure described above with reference to FIGS. 1 through 10, the convolution tensor identifying module 17a, a tiling direction determining module 17b, the tile matrix generating module 17c, the LRA executing module 17d, and the U convolution tensor/V convolution tensor generating module 17e. However, the electronic device 10 may compress an AI neural network model by more software modules than those shown in FIG. 13 or less software modules than those shown in FIG. 13.

For example, as the processor 13 executes an instruction included in the convolution tensor identifying module 17a, the electronic device 10 may identify a convolution tensor included in a convolution layer of the AI neural network model from a structure of the AI neural network model stored in the memory 17 or received from the server. Detailed descriptions of the embodiments of the disclosure described above with reference to FIGS. 1 through 11 will be omitted.

In another example, as the processor 13 executes an instruction included in the tiling direction determining module 17b, the electronic device 10 may determine a tiling direction for a plurality of sub-matrices based on a size of an input channel of a convolution tensor, a size of an output channel of the convolution tensor, the number of columns of a convolution kernel formed by the convolution tensor, and the number of rows of the convolution kernel. Detailed descriptions of the embodiments of the disclosure described above with reference to FIGS. 1 through 11 will be omitted.

In another example, as the processor 13 executes an instruction included in the tile matrix generating module 17c, the electronic device 10 may generate a tile matrix by tiling a plurality of 2D sub-matrices in a determined direction (e.g., vertically, horizontally, or bidirectionally). Detailed descriptions of the embodiments of the disclosure described above with reference to FIGS. 1 through 11 will be omitted.

In another example, as the processor 13 executes an instruction included in the LRA executing module 17d, the electronic device 10 may identify a sharing matrix from a tile matrix and perform LRA on the tile matrix based on the sharing matrix to generate a U matrix and a V matrix. Detailed descriptions of the embodiments of the disclosure described above with reference to FIGS. 1 through 11 will be omitted.

In another example, as the processor 13 executes an instruction included in the U convolution tensor/V convolution tensor generating module 17e, the electronic device 10 may generate a U convolution tensor by recombining a U matrix and generate a V convolution tensor by recombining a V matrix, by executing the U convolution tensor/V convolution tensor generating module 17e. Detailed descriptions of the embodiments of the disclosure described above with reference to FIGS. 1 through 11 will be omitted.

Some embodiments of the disclosure may be implemented with a recording medium including a computer-executable instruction such as a computer-executable programming module. A computer-readable recording medium may be an available medium that is accessible by a computer, and include all of a volatile medium, a non-volatile medium, a separated medium, and a non-separated medium. The computer-readable recording medium may also include a computer storage medium. The computer storage medium may include all of a volatile medium, a non-volatile medium, a separated medium, and a non-separated medium, which is implemented by a method or technique for storing information such as a computer-readable instruction, a data structure, a programming module, or other data.

Some of the embodiments of the disclosure have been shown and described above. However, the one or more embodiments of the disclosure are not limited to the aforementioned specific embodiments. It may be understood that various modifications, substitutions, improvements and equivalents thereof can be made without departing from the spirt and scope of the disclosure. It should be understood that such modifications, substitutions, improvements and equivalents thereof shall fall within the protection scope of the disclosure, and should not to be construed independent from the inventive concept or prospect of the disclosure.

What is claimed is:

1. A method of compressing a convolutional neural network (CNN) including at least one convolution layer, performed by an electronic device, the method comprising:
identifying a convolution tensor of the at least one convolution layer;
determining a tiling direction for the convolution tensor based on a shape of the convolution tensor;
generating a tile matrix from the convolution tensor along the tiling direction;
generating a U matrix and a V matrix by performing low rank approximation (LRA) on the tile matrix; and
generating a U convolution tensor by recombining the U matrix and generating a V convolution tensor by recombining the V matrix.

2. The method of claim 1, wherein the determining the tiling direction for the convolution tensor comprises:
dividing the convolution tensor into a plurality of sub-matrices comprising a row of a size corresponding to a size of an input channel and a column of a size corresponding to a size of an output channel; and
determining tiling directions for the plurality of sub-matrices based on the size of the input channel of the convolution tensor, the size of the output channel of the convolution tensor, a number of columns of a convolution kernel formed by the convolution tensor, and a number of rows of the convolution kernel.

3. The method of claim 2, wherein the determining the tiling direction for the convolution tensor further comprises determining the tiling directions for the plurality of sub-matrices based on a result of comparing a greater value between the number of columns of the convolution kernel and the number of rows of the convolution kernel with a ratio of the size of the output channel to the size of the input channel.

4. The method of claim 3, wherein the determining the tiling direction for the convolution tensor further comprises determining to tile the plurality of sub-matrices vertically based on the greater value between the number of columns of the convolution kernel and the number of rows of the convolution kernel being less than the ratio of the size of the output channel to the size of the input channel.

5. The method of claim 3, wherein the determining the tiling direction for the convolution tensor further comprises determining to tile the plurality of sub-matrices horizontally based on a reciprocal of the greater value between the number of columns of the convolution kernel and the number of rows of the convolution kernel being greater than the ratio of the size of the output channel to the size of the input channel.

6. The method of claim 3, wherein the determining the tiling direction for the convolution tensor further comprises determining to tile the plurality of sub-matrices horizontally as many as the number of columns of the convolution kernel and determining to tile the plurality of sub-matrices vertically as many as the number of rows of the convolution kernel, based on a result of the greater value between the number of columns of the convolution kernel and the number of rows of the convolution kernel being greater than the ratio of the size of the output channel to the size of the input channel, and the reciprocal of the greater value between the number of columns of the convolution kernel and the number of rows of the convolution kernel being less than the ratio of the size of the output channel to the size of the input channel, respectively.

7. The method of claim 2, wherein the generating the U matrix and the V matrix comprises:
identifying a sharing matrix from the tile matrix along at least one of the tiling directions for the plurality of sub-matrices; and
generating the U matrix and the V matrix by performing the LRA based on the identified sharing matrix.

8. An electronic device for compressing a convolutional neural network (CNN) including at least one convolution layer, the electronic device comprising:
a memory storing at least one instruction; and
a processor configured to execute the at least one instruction to:
identify a convolution tensor of the at least one convolution layer;
determine a tiling direction for the convolution tensor based on a shape of the convolution tensor;
generate a tile matrix from the convolution tensor along the tiling direction;
generate a U matrix and a V matrix by performing low rank approximation (LRA) on the tile matrix; and
generate a U convolution tensor by recombining the U matrix and generate a V convolution tensor by recombining the V matrix.

9. The electronic device of claim 8, wherein the processor is further configured to execute the at least one instruction to:
divide the convolution tensor into a plurality of sub-matrices comprising a row of a size corresponding to a size of an input channel and a column of a size corresponding to a size of an output channel; and
determine tiling directions for the plurality of sub-matrices based on the size of the input channel of the convolution tensor, the size of the output channel of the convolution tensor, a number of columns of a convolution kernel formed by the convolution tensor, and a number of rows of the convolution kernel.

10. The electronic device of claim 9, wherein the processor is further configured to execute the at least one instruction to determine the tiling directions for the plurality of sub-matrices based on a result of comparing a greater value between the number of columns of the convolution kernel and the number of rows of the convolution kernel with a ratio of the size of the output channel to the size of the input channel.

11. The electronic device of claim 10, wherein the processor is further configured to execute the at least one instruction to determine to tile the plurality of sub-matrices vertically based on the greater value between the number of columns of the convolution kernel and the number of rows of the convolution kernel being less than the ratio of the size of the output channel to the size of the input channel.

12. The electronic device of claim 10, wherein the processor is further configured to execute the at least one instruction to determine to tile the plurality of sub-matrices horizontally based on a reciprocal of the greater value between the number of columns of the convolution kernel and the number of rows of the convolution kernel being greater than the ratio of the size of the output channel to the size of the input channel.

13. The electronic device of claim 10, wherein the processor is further configured to execute the at least one instruction to determine to tile the plurality of sub-matrices horizontally as many as the number of columns of the convolution kernel and determine to tile the plurality of sub-matrices vertically as many as the number of rows of the convolution kernel, based on a result of the greater value between the number of columns of the convolution kernel and the number of rows of the convolution kernel being greater than the ratio of the size of the output channel to the size of the input channel, and the reciprocal of the greater value between the number of columns of the convolution kernel and the number of rows of the convolution kernel being less than the ratio of the size of the output channel to the size of the input channel, respectively.

14. The electronic device of claim 9, wherein the processor is further configured to execute the at least one instruction to:
identify a sharing matrix from the tile matrix along at least one of the tiling directions for the plurality of sub-matrices; and
generate the U matrix and the V matrix by performing the LRA based on the identified sharing matrix.
